(19) United States
(12) Patent Application Publication
(10) Pub. No.: US 2014/0106964 A1
(43) Pub. Date: Apr. 17, 2014

(54) SEED COATING FORMULATION SYSTEMS

(71) Applicant: Crop Enhancement, LLC, Cambridge, MA (US)

(72) Inventors: Gangadhar Jogikalmath, Cambridge, MA (US); Andrea Schneider, Hyde Park, MA (US); David S. Soane, Chestnut Hill, MA (US)

(73) Assignee: Crop Enhancement, LLC, Cambridge, MA (US)

(21) Appl. No.: 14/054,099

(22) Filed: Oct. 15, 2013

Related U.S. Application Data
(60) Provisional application No. 61/714,532, filed on Oct. 16, 2012.

(51) Int. Cl. A01C 1/06; A01N 43/70; A01N 43/707

(52) U.S. Cl. CPC A01C 1/06; A01N 43/707; A01N 43/70
USPC 504/100; 504/229; 504/234

(57) ABSTRACT

The present invention provides seed coating systems and methods for their use, where a seed coating system comprises encapsulated active ingredient particles that comprise an active ingredient and an encapsulation layer with a preselected release profile, and a polymeric seed coating, wherein the polymeric seed coating releasably affixes the encapsulated active ingredient particle in proximity to a surface of a seed. In embodiments, the seed coating system comprises a plurality of active ingredient layers, wherein a first active ingredient layer comprises a first encapsulated active ingredient, wherein the first encapsulated active ingredient is encapsulated in a first polymer, and wherein the polymer comprises a first binding site that binds the active ingredient and a second binding site for binding to a delivery area, and a binder to releasably affix the encapsulated active ingredient to at least one of a seed surface or a second active ingredient layer, and wherein a second active ingredient layer comprises a second encapsulated active ingredient, wherein the second encapsulated active ingredient is encapsulated in a second polymer which may be the same as or different from the first polymer, and a binder to releasably affix the encapsulated active ingredient to at least one of the first active ingredient layer and a subsequent active ingredient layer.

### RELATED APPLICATION

This application claims the benefit of U.S. Provisional Application Ser. No. 61/714,532 filed Oct. 16, 2012. The entire contents of the above-referenced application are incorporated by reference herein.

### FIELD OF THE APPLICATION

This application relates to attaching water soluble and sparingly soluble biologically active small molecules and fertilizers to seeds.

### BACKGROUND

Modern agriculture practices and the changing climate make it desirable that the seeds contain specific protections against premature germination to enhance uniformity in crop growth rates and to optimize production timetables. The seeds used in modern agriculture can be coated with a variety of chemical agents to enhance their performance, and to optimize the growth and development of the plant structures following germination. Chemicals useful as seed coatings can include agents that function as plant growth regulators, pesticides, herbicides, fertilizers, growth/germination control factors and the like.

Chemical coatings can be imparted to seeds using, for example, a film coating process wherein a certain stoichiometry of chemicals is mixed with a suitable binder and deployed as a film. A difficulty with such coating processes is timing. Crop-enhancement chemicals can be useful during the stages of germination and growth, while coating technologies as described above are applied to the seed at an earlier stage, for example pre-germination. Traditional coating techniques do not readily allow for the release of different chemical coatings at different times in the seed lifecycle.

As another example, a pesticide that might be used to coat a seed before germination might need to become efficacious only after the seed has germinated. Or, as another example, a fertilizer in the coating might be expected to release its active ingredient(s) over a prolonged period, perhaps during the entire germination period. An active ingredient expected to be effective over such a long period during the seed lifecycle can be vulnerable to ambient conditions where the seed has been planted, such as rainfall, soil moisture conditions, temperature variability, sun exposure, and the like. When the active components of a seed coating are hydrophobic, they are especially vulnerable to rain and moisture, because they bind poorly to the soil components themselves; such agents are susceptible to run-off, with consequent loss of effectiveness and with undesirable accumulation in surrounding waterways. Moreover, agents having long activity phases that are applied to seeds can be eroded by biological activities in the field, such as microorganisms, pests and weeds.

There remains an overall need in the art for an application technology that improves seed coatings to allow various active ingredients to be effective over a prolonged period of time and at a particular time in the seed lifecycle. There remains a further need to protect seed coatings from environmental activities that can degrade the active ingredients or remove them from the seed in whole or in part, so that seed yields are enhanced, and so that germinating seeds are protected from pests and weeds. There is a further need to protect the soil and waterways around agricultural areas from contamination attributable to aqueous run-off or airborne dispersion.

### SUMMARY

Disclosed herein, in embodiments, are seed coating systems, comprising an encapsulated active ingredient particle comprising an active ingredient and an encapsulation layer with a preselected release profile, and a polymeric seed coating, wherein the polymeric seed coating releasably affixes the encapsulated active ingredient particle in proximity to a surface of a seed. In embodiments, the encapsulation layer is polymeric. In embodiments, the encapsulation layer is rigid or semi-rigid. The encapsulated active ingredient particle can be formed as a hollow sphere. In embodiments, the seed coating system further comprises an external polymeric layer over the hollow sphere. In embodiments, the encapsulated active ingredient particle comprises two or more active ingredients within a single encapsulated active ingredient particle. The encapsulation layer can be selected from the group consisting of SMA and SMI, hydrophobic proteins, other proteins, starches, hydrophobically derivatized starches, hydrophobically modified water soluble proteins and naturally derived polymers suitably modified by entities that enable them to bind to the delivery area, natural waxes, alkyl chain fatty acids and their derivatives. In embodiments, the polymeric seed coating is biodegradable. The system can further comprise a second active ingredient particle having either a second active ingredient or a second preselected release profile.

Further disclosed herein, in embodiments, is a seed coating system comprising a plurality of active ingredient layers, wherein a first active ingredient layer comprises a first encapsulated active ingredient, wherein the first encapsulated active ingredient is encapsulated in a first polymer, and wherein the polymer comprises a first binding site that binds the active ingredient and a second binding site for binding to a delivery area, and a binder to releasably affix the encapsulated active ingredient to at least one of a seed surface or a second active ingredient layer, and wherein a second active ingredient layer comprises a second encapsulated active ingredient, wherein the second encapsulated active ingredient is encapsulated in a second polymer which may be the same as or different from the first polymer, and a binder to releasably affix the encapsulated active ingredient to at least one of the first active ingredient layer and a subsequent active ingredient layer. In other embodiments, a retention system is disclosed for an active ingredient on a seed, comprising a coated particle bearing the active ingredient, a polymeric overcoat covering the coated particle and permitting controlled release of the active ingredient therethrough, and a binder that coats the seed and that attached the coated particle thereto.

Also disclosed herein, in embodiments, are methods of producing more effective germination of a seed, comprising preparing the seed coating system as described above, applying an effective amount of the seed coating system to a seed to form a coated seed, introducing the coated seed into a treatment area, and exposing the coated seed in the treatment area to a germination condition, wherein the coated seed responds to the germination condition to germinate more effectively than an identical seed without the seed coating system applied. In embodiments, the germination condition is selected from the group consisting of soil moisture, soil pH, temperature, sun exposure, nutrient exposure, and passage of time.

The invention also encompasses a seed coated with a seed coating system described herein.

### BRIEF DESCRIPTION OF THE FIGURES

FIG. 1A shows schematically the components of a seed coating system.

FIG. 1B shows in more detail a schematic of an encapsulated active ingredient.

FIG. 2 shows a graph of absorbance vs. release time for two seed coating preparations.

FIGS. 3A-C show photographs of weed density under control and experimental conditions, in the presence and absence of seed coating systems.

### DETAILED DESCRIPTION

### 1. Seed Coating Formulation Systems

Disclosed herein, in embodiments, are seed coating formulation systems able to attach one or more active ingredients to a seed surface so that differential release patterns can be achieved. The seed coating formulations can comprise an active ingredient having a polymeric encapsulation layer or other sort of encapsulation with specific release properties. The encapsulated active ingredient is affixed to the seed by a polymeric coating having its own specific release properties.

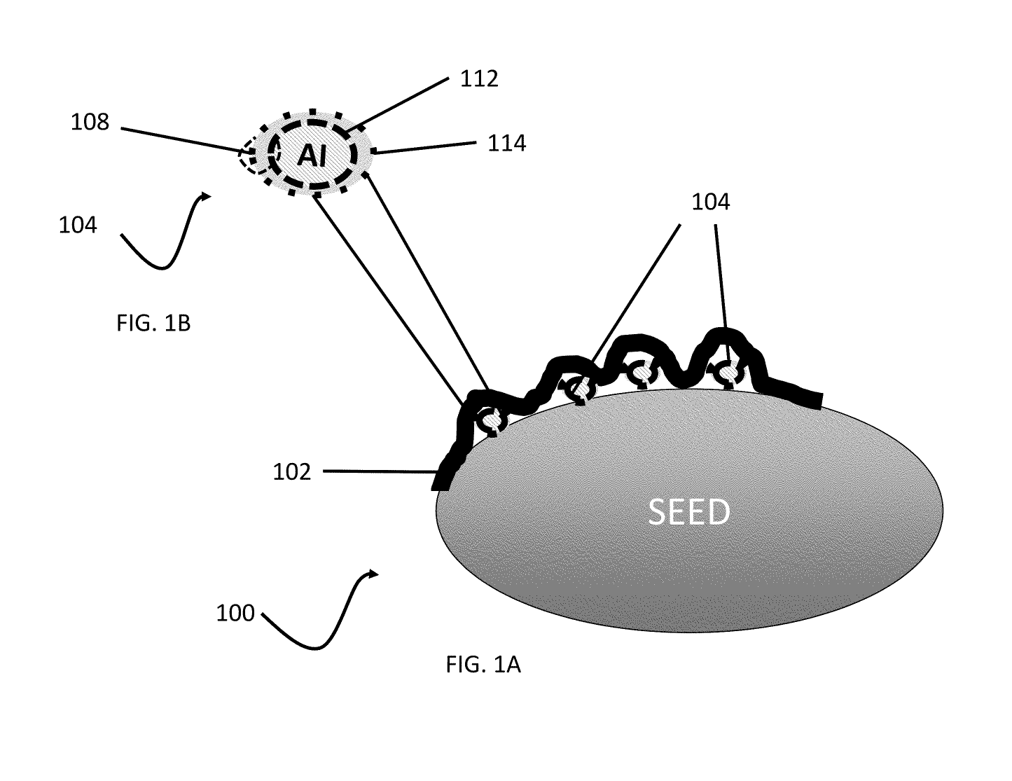

FIGS. 1A and 1B set forth an illustrative embodiment of the seed coating formulation systems disclosed herein. As shown in FIG. 1A, a seed coating formulation system includes a SEED bearing on its surface a polymeric coating layer 102 that attaches multiple encapsulated active ingredient particles 104 to the SEED. The encapsulated active ingredient (“EAI”) particles 104 contain an active ingredient AI surrounded by an encapsulation layer 108, as shown in more detail in FIG. 1B. The EAI particles 104, whether spherical, ovoid, or shaped in other geometric arrangements, can have a largest diameter between about 4 to about 10 microns, typically less than about 200 microns to avoid clogging the apparatus used to dispense them onto the SEED surface. The EAI particles 104 are affixed or bound to the SEED surface using an outer polymeric coating 102 that can gradually release the EAI particles 104 from the SEED surface as desired during the seed lifecycle. The release profile for the outer polymeric coating 102 can be determined by the thickness of such coating, or by its biodegradability, or by its susceptibility to temperature, soil pH, moisture, or other environmental characteristics. The outer polymeric layer 102 in FIG. 1A is shown as conforming to the shape of the EAI particles 104. This diagram is not to scale, and does not represent the specific morphology of the outer polymeric coating 102 as it affixes, enrobes or otherwise attaches the EAI particles 104. For example, the EAI particles 104 need not directly contact the seed surface, but may instead be suspended in the outer polymeric coating 102. The coating 102 need not be applied conformally. The coating 102 can be continuous or discontinuous. The outer polymeric coating 102 can be much thicker than the outer diameter of the EAI particles 104, having for example a thickness of few microns to a few millimeters, with thickness depending, inter alia, on the size of the seed being coated. As depicted herein, only one type of EAI particle 104 is attached to the seed. However, a plurality of EAI particle types can be attached, each type having its own AI if desired, or having the same AI but with different encapsulation layers so that the AI is released according to a variety of AI release profiles.

As shown in FIG. 1B, an active ingredient AI can be encapsulated by an encapsulation layer 108 to form an encapsulated active ingredient particle 104. The encapsulation layer 108 may be a polymer, e.g., a block copolymer, having moieties that form an inner-facing aspect 112 having affinity for the AI and an outer-facing aspect 114 having affinity for the treatment area where the AI is to be bound. As used herein, the term “active ingredient” or AI refers to the compound being delivered to the treatment area having the desired pharmacological effect, e.g., a compound or compounds that are herbicides, fungicides, growth regulators, fertilizers, nutrients, germination aid, growth regulators, and the like. As used herein, the term “treatment area” refers to any area where the effect of the small molecule active ingredient in question would otherwise be desirable, e.g., as an herbicide, anti-mold or antifungal agent, a growth enhancing agent, or as an insecticide.

In embodiments, the EAI particles 104 are initially bound to the SEED by the polymeric coating 102, with the encapsulation layer 108 having an affinity to the AI through its inner-facing molecular aspect 112, and having an affinity for the soil or other treatment area through its outer-facing molecular aspect 114. As the polymeric coating 102 erodes, is metabolized, dissolves, or otherwise loosens the attachment of the EAI particles 104 to the SEED, the EAI particles migrate away from the SEED towards the treatment area, and the EAI particles are bound thereto by the outer-facing molecular attachment 114 of the encapsulation layer 108. The release of the AI into the treatment area is then mediated by the properties of the encapsulation layer. In embodiments, a single AI can be provided with several different types of encapsulation layers 108 so that the single AI can have varying release profiles. In embodiments, a plurality of AIs can be encapsulated and affixed to seeds using these systems and methods, thereby addressing different features of seed growth and/or encountering different treatment areas. In embodiments, use of encapsulated active ingredient particles as described herein permits enhanced retention for the active ingredients in the treatment area and prevents their leaching therefrom.

In other embodiments, an active ingredient can be encapsulated with a physical structure, for example a porous particle into which the active ingredient can be imbibed. In such embodiments, small porous particles can be natural, synthetic, organic, or inorganic, capable of bearing the active ingredient internally. These small “packets” containing the active ingredient can be surface-coated with an ultrathin polymer layer that provides additional functionality, for example prolonged release (with controlled leaching kinetics) and high affinity towards soil components. The ultrathin polymer layer may be further augmented with water dispersible molecular branches to promote colloidal dispersion stability, so the formulation remains shelf-stable rheologically. Active-ingredient-bearing “packets” using porous particles for encapsulation can be prepared having suitable dimensions for attachment to the seed surface, using the polymeric coating layer as described previously. For example, small vesicular structures can be used ranging in size from tens of nanometers to hundreds of microns.

An additional advantage of using encapsulated active ingredient particles as disclosed herein for treating seeds is a reduction in photo-degradation for the active ingredients. In the first system, carriers designed with affinity for the aromatic composition of an active ingredient, e.g., an herbicide, can comprise copolymers that are primarily aromatic in structure, thus imparting UV opacity to the resulting complexes. In the second system, porous particles selected to contain the active ingredients can be intrinsically UV opaque, due to light scattering accompanying the porous morphology of such “containers.”

### 2. Encapsulated Active Ingredient Particle Preparation

As previously described, encapsulated active ingredient particles can be prepared by enveloping the selected active ingredient in a polymeric encapsulation layer where the layer has certain moieties with affinities for the active ingredient, and certain moieties with affinities for the treatment area, for example the soil. Very generally, the hydrophobic (e.g., aromatic) nature of active ingredients differs from the hydrophilic environment of the treatment area or the plant surface. Hence, the encapsulation layer can be designed to engage both these milieus.

To create a polymer-based encapsulation layer for seed treatment AIs, a system for aromatic ingredients for example, polymeric additives having aromatic structures can be affixable or otherwise associable with components of the soil or components of the growing plant surface, so that the polymeric additive bearing the aromatic active ingredient would be attracted thereto. In embodiments, a styrene maleimide (“SMI”) polymer can be employed in a polymeric encapsulation layer. Polymers made with styrene and maleimide monomers (i.e., SMI polymers) can be solubilized in acidic aqueous solutions and can possess cationic charges. The cationic groups of a SMI polymer can bond electrostatically to negatively charged components of soil such as sand and clay. Alternatively, a SMI polymer can be precipitated onto a substrate such as an anionic particle by changing the pH of the solution. By increasing the pH, the SMI will precipitate to enable even higher retention of the polymer onto a surface. This is a reversible process and the SMI can also be re-solubilized by again lowering the pH to a sufficient level. SMI polymers concomitantly can retain aromatic active ingredients by pi-pi stacking, so that such active ingredients can be delivered to the delivery area and be retained there.

In embodiments, an encapsulation system for active ingredient compounds that have an aromatic structure can comprise polymers containing aromatic structures via pi-pi stacking interactions. Not to be bound by theory, a chemical compound with phenyl rings, for example, can be associated with a polymeric matrix by the use of pi-pi stacking involving flat aromatic structures with pi electron clouds that overlap with neighboring aromatic structures resulting in strong interactions between them. For example, phenoxy acid herbicides (e.g., 2,4-D (WEEDONE®), mecoprop (MCPP) and 2,4-D plus 2,4-DP (WEEDONE® DPC)), benzoic acid herbicides (e.g., dicamba) and pyridine herbicides (e.g., dithiopyr), can demonstrate pi-pi stacking association with polymers such as those disclosed herein.

Other polymers having phenyl groups or other aromatic configurations can be used similarly to create an aromatic, inner-facing aspect for active ingredients with phenyl rings to interact or associate with. In embodiments, other configurations of SMI polymers can be used for these applications, e.g., where the styrene to maleimide ratio is varied, creating either more phenyl groups or maleimide groups on the surface of the particles. The additional phenyl groups on the polymer can cause the polymeric substrate to exhibit increased hydrophobicity. Not to be bound by theory, but it is understood that increased hydrophobicity can limit access to the payload, thereby limiting its release over time. In alternate embodiments, a polymeric substrate like SMI can be precipitated onto materials such as precipitated calcium carbonate (“PCC”) or silica. Other fillers can include materials such as clay, sand, diatom, zeolite, porous silica, and the like. These functionalized fillers, bearing SMI on their surfaces, can provide interaction points for the highly aromatic compounds, and can be used to form encapsulated active ingredient particles.

In other embodiments, other polymers containing phenyl groups can be used to form encapsulation layers for aromatic compounds. As an example, styrene maleic anhydride (“SMA”) polymers can be used for these purposes. An SMA polymer does not show pH-mediated precipitation onto surfaces. Using a binding agent such as chitosan, however, SMA can be associated with a particle that has been premodified with chitosan. The particle can be hollow, porous or solid. In embodiments, the particles can be loaded with AIs inside them, using the SMA-Chitosan conjugate as a release coating. In embodiments, a binding agent like chitosan can be used to coat the particle surface, either by pH-mediated precipitation or by electrostatic attraction (with PCC as the surface, for example). Once the surface of the particle is coated with a polyamine binding agent, such as chitosan, the amine groups of the chitosan layer can react with the anhydride groups of the SMA to associate the SMA with the material or matrix. The particles bearing the SMA can then be associated with one or more designated aromatic active ingredient(s) in a manner similar to particles bearing SMI, as described above.

In other embodiments, two different formulations could be prepared as described above, for example, a SMA-based formula complexed with one active ingredient, and a SMI-based formula complexed with another active ingredient. The two formulations could then be combined to form a single encapsulated active ingredient particle yielding dual activity and/or controlled dosage. In other embodiments, a SMA-based formulation could be provided to contribute reactive groups for binding an active ingredient, and an SMI-based formulation could be provided to contribute cationic groups to bind the soil. The two formulations could then be combined within a single encapsulated active ingredient particle system.

In other embodiments, copolymers of polyethylene glycol (“PEG”) or polypropylene glycol (“PPG”) and polystyrene can be used for associating aromatic active ingredients with particles. In using such a polymer, the PEG or PPG components of the polymer can allow it to be precipitated onto the filler by increasing the temperature above the LCST (lower critical solution temperature) of the polymer. Raising the temperature above the LCST can render the polymer insoluble, thereby permitting it to coat the substrate. In this configuration, the polystyrene component of the polymer can permit association with aromatic compounds that are active ingredients via pi-pi stacking, while the PEG or PPG component permits association of the polymer with the substrate, with particles and/or with the soil or other substrates. For example, the active ingredient could be introduced into a porous particle system with a LCST polymer acting as an overcoat controlling the release of the active ingredient. In embodiments, other copolymers that combine components exhibiting an LCST with components containing a phenyl group would be suitable for these applications.

In one embodiment, a water-soluble active ingredient, e.g., an herbicide compound, can be mixed with a 1% starch solution. This starch solution can then be crosslinked with the use of crosslinkers such as glyoxal or glutaraldehyde into a solid mass. The solid mass can then be crushed to make smaller particles that are porous and that have the active ingredient loaded inside. This encapsulated active ingredient particle can then be attached to a seed using the systems and methods disclosed herein.

In another embodiment, a water insoluble active ingredient, e.g., an herbicide (preferably comprising one or more phenyl rings in its chemical structure; or an aromatic herbicide), can be mixed with a block copolymer of SMI or SMA so as to associate the active ingredient with the polymer. This system could then be mixed with an anionic carrier such as zeolite, diatomaceous earth or porous silica. The SMI would bind to the particle via electrostatic attraction. The carrier system could then be coated with a thin layer of cationic polymer such as chitosan (naturally occurring polymer) or polyvinylamine or similar. The cationic polymer, forming the outer-facing aspect of the encapsulated active ingredient particle, then allows the binding of the carrier system to soil components such as sand or clay. Encapsulated active ingredient particles prepared by these methods can then be attached to a seed using a polymeric coating.

In embodiments, LCST polymers could be used to encapsulate active ingredients, thereby forming encapsulated active ingredient particles. For example, a gel made of crosslinked PPO-PEO copolymer with an LCST of 20° C. could be used. The active ingredient is mixed with prepolymer at temperature below LCST. Then the crosslinking reaction is initiated either by providing a crosslinking agent or by adding another polymer that will crosslink but form an interpenetrated network with the LCST polymer when the temperature of the polymer solution is raised above LCST resulting in precipitation of LCST polymer. Thus encapsulated, the active ingredient can be further encased in a cationic polymer, such as chitosan, which can be precipitated onto the gel particle, enabling the encapsulated system to attach to soil or other substrates. Encapsulated active ingredient particles prepared by these methods can then be attached to a seed using a polymeric coating.

In another embodiment, porous carrier particles bearing active ingredients (as described above) can be coated with a thin layer of another polymer such as CMC or dextran or other similar biodegradable polymers before being coated with a cationic polymer. The presence of biodegrading polymer enables the slow release of the active ingredient from the interior of the particle as the coating is degraded or, e.g., consumed slowly by bacteria that reside in the treatment area. In other embodiments copolymers of acrylic monomers could be designed and used to create encapsulation layers for encapsulated active ingredient particles. These acrylic compounds are temperature sensitive, with their Tg (glass transition temperatures) being tuned to soften when the temperature of the soil surrounding them reaches appropriate temperature. Encapsulated active ingredient particles prepared by these methods can then be attached to a seed using a polymeric coating.

In other embodiments, the carrier polymers such as SMI or the LCST polymers can be mixed with polymers containing conjugated structures such as double bonds or with a small amount of carbon black to form encapsulation layers. These materials absorb UV light and shield the active ingredient compounds which might be photodegradable.

In other embodiments, proteins such as zein, casein, and other such hydrophobic proteins that display a pH sensitive solubility behavior can be used to form encapsulation layers around encapsulated active ingredient particles. Encapsulated active ingredient particles prepared by these methods can then be attached to a seed using a polymeric coating. In other embodiments, as described previously, an encapsulated active ingredient particle system suitable for use with the polymeric seed coatings described herein can comprise porous particles instead of or in addition to one or more polymeric encapsulation layers. Using such a system, active ingredients (either water soluble or sparingly soluble) can be incorporated into small “packets” (micron size or larger) made from specifically engineered particulate matter comprising such materials as starch granules, polyacrylic acid (various crosslinking degrees and sizes), zeolite, diatomaceous earth, or porous silica. Once fully imbibed in the porous structure, the loaded packets bearing the active ingredient can be over-coated with an ultrathin (i.e., monolayer or bi-layer) self-assembling polymer that controls release kinetics and provides simultaneous soil adherence.

In embodiments, in addition to, or in lieu of the self-assembly of polymeric encapsulation layers, a core-shell system can be formed to produce encapsulated active ingredient particles. In such encapsulated active ingredient particles, the core, having either nanochannels or sparing intrinsic water solubility, provides for slow release and controlled water permeation, thus prolonging discharge of the active ingredient into the treatment area. The core can contain just a single AI particle thus encapsulated, or it can have a plurality of embedded particles dispersed throughout a continuous matrix (like chocolate chips in a cookie). Surrounding the core can be an encapsulation layer “skin”, formed from an ultrathin monolayer or near monolayer polycation. The formulated core thus is encased in an ultrathin outer layer, which can be a monolayer or near-monolayer of a polycation. Encapsulated active ingredient particles prepared by these methods can then be attached to a seed using a polymeric coating. The core-shell system for forming encapsulated active ingredient particles can use a variety of active ingredients as cores, along with a variety of formulations for the encapsulation layer shell.

Polymers suitable for the coating to be applied to the AI-bearing cores are, in embodiments, polycations. These polycations are selected largely for their hydrophilicity and cationic charges. Because the charges on the target substrates, e.g., soil, are largely anionic in nature, these characteristics can enhance the attraction of the formulations for such targets. In embodiments, the coating polymers can be naturally derived, for example, proteins and glucosamines. In embodiments, the coating polymers can have a switchable solubility profile, as a function, for example, of pH, temperature or ionic strength, to enable the facile deposition of these coatings on the AI-bearing core matrices. For the coating layer, the polymers can desirably be controllably deposited on the core matrix by precisely titrating the pH of the system. Exemplary polycations include SMAi (imidized styrene maleic anhydride), zein, casein, or any of a number of polyamines (such as polyvinylamine, polyallylamine, polyethylenimine), and their derivatives (such as PEGylated varieties), DADMAC, chitosan (and its derivatives including different degrees of hydrolysis from chitin), and other cationic proteins or glycoproteins. The coating process can be done at elevated temperatures in a set-up similar to sugar coating of confectionary. Equivalently, it can be performed in a high-shear device, where intense shearing provides an even and thin coating over the AI kernel (or multiple kernels).

In embodiments, the inner core can be formed through an anhydrous process, beginning with one or more solid AI powders. In addition, up to four basic ingredients can be used to form the core matrix: wax, oil, olefin polymer or co-polymer and fatty acid. Wax is a basic building block of the formulation. Wax is paraffin and has a low melting temperature. Under high shear conditions, it turns into a melt. Candle wax and bees wax are both acceptable examples. Oil can be a vegetable oil, such as palm oil, to maximize the “bio-derived” characteristic of the formulation. Alternatively, mineral oil can be used as a substitute. A small amount of an olefin polymer or co-polymer may be optionally added to preserve the geometrical integrity of the encapsulated product in hot climate. Finally, a fatty acid, such as stearic acid, can be added to impart additional water compatibility and ensure a negative surface charge to attract the final deposition of the polycation surface layer after the core is formed.

Wax is hydrophobic, thus ensuring little water ingression and sustained release. The optional polymer additive imparts mechanical stability of the overall structure. Vegetable oil is compatible with wax and its employment serves to tune the water ingression rate into the encapsulated particles over orders of magnitude. In case even higher water penetration rates are desired, a small amount of glycerin can be co-added with the oil. Finally, fatty acids in the formulation create an overall anionic charge characteristic of the encapsulated particle, which ensures good adhesion with the final coating of a polycation surface layer. The hydrophobic tail of the fatty acid makes this material compatible with the wax base.

In accordance with this embodiment, the matrix ingredients can be first mixed thoroughly in a high shear mixer, and then broken into fine particles. Alternatively, a non-polar but volatile solvent can be used to assist mixing. The mixture is added to a high shear mixer containing AI, at a matrix:AI ratio of less than 1:1 to minimize consumption of the encapsulant ingredients.

In another embodiment, an inner core can be formed through an anhydrous process, using a dilute polymer solution in a non-aqueous solvent. In embodiments, the matrix material can be a derivatized cellulose, for example, acetylated, propylated, butyrated cellulose (single and multiple substitutions) and poly-ethers of derivatized celluloses, and copolymers or mixtures of these two groups. This material is combined with one or more volatile and benign solvents such as acetone and/or isopropyl alcohol as a casting solvent. To form the matrix with the encapsulated AI, a free flowing powder of AI is selected, then added slowly to a dilute solution of the matrix material in a mixing vessel. Evaporation of the solvent and agitation of the mixture are carried out so as to provide an even and thin coating on the AI. Plasticizers such as glycerin and PEG can be added into the encapsulation solution to tune the release kinetics of the final particles.

In another embodiment, an inner core can be formed through a process using a small amount of water. As the initial component, a highly absorbent material such as crosslinked polyacrylic acid (“PAA”), which exists in the salt form at neutral pH, can be selected, which is capable of imbibing great quantities of a concentrated aqueous solution. This material can be formed as particles or beads that are initially dry. Then, a water-soluble AI can be dissolved in a small amount of water to make a high concentration solution. The dry absorbent powder is then intimately mixed with the AI solution, whereupon the mixture quickly turns into a thick paste, with a large proportion of the AI being internalized within the adsorbent particles or beads. At this point, little residual aqueous solution is left in the interstitial space between the swollen particles or beads of the absorbent.

After the ingression of the AI into the absorbent particles or beads, a cationic polymer solution can then be added to the paste, causing such polymer to immediately precipitate onto the surface of the absorbent particles or beads. Strong charge-charge attraction provide for rapid polymer deposition and immediate sealing of the AI content within the beads. Previously imbibed water can continue to escape from the particles or beads, at an evaporative rate that can be enhanced with the application of heat. With sufficient evaporation, a dry flowing powder of absorbent material (e.g., PAA) remains, containing the internally trapped AI; the particles or beads will be surface-coated with a thin layer of the polycation. With this method of encapsulation, the diffusion barrier controlling AI release is primarily formed by the strong bi-polymer interaction (cationic top-coat and anionic crosslinked matrix). To further restrict AI release, the polycations used for the surface coating may be derivatized with hydrophobic side groups. For example, chitosan or polyamines may be pre-reacted (or derivatized post-deposition) with short-chain aliphatics with an epoxy group.

The encapsulated active ingredient particles prepared as described above can simultaneously exhibit sustained release of the AI(s) with controllably tunable kinetics, high loading capacity, high affinity binding to substrates, and environmentally-friendly yet low-cost “packaging” matrices. Active ingredients suitable for formulation in accordance with the systems and methods disclosed herein can include compounds such as triazines (atrazine and cyanazine), alachlor (chlorinated acetamide), benazolin, bentazone, imazapyr and triclopyr, sulfonyl urea based herbicides, and the like.

### 3. Seed Coating Formulation Systems

Encapsulated active ingredient particles, as described above, can be attached to seeds using a variety of polymeric coatings. As used herein the term “seeds” can refer to embryonic plants that could be sown to germinate a new plant; such seeds generally contain an embryo, nutrients for the embryo and often a protective coat. The term “seeds” can also refer to fruits of the plant in dried form. The term “seeds” can also refer to pieces of the fruit or tuber such as the potato seedlings. Seeds can be protected in a hardshell like the pits of certain fruits or in a husk like rice. Attaching the encapsulated active ingredient particles, as described above, to the seeds permits their attachment to the seeds until their activity is appropriate for the seeds' lifecycle. A seed, when planted in a treatment area, is exposed to a variety of germination conditions that lead to its germination into a new plant. Germination conditions can include environmental factors such as soil moisture, soil pH, sun exposure, temperature, nutrient exposure, and passage of time. Germination conditions can also include the absence of unfavorable environmental factors such as an absence of pests, weeds and/or microbes.

The attachment and release profile of the active ingredient in the treatment area is typically mediated by the encapsulation layer of the encapsulated active ingredient. The polymeric coating affixing the encapsulated active ingredients allows for the environmentally determined release of the encapsulated active ingredient from the seed surface into the treatment area.

Encapsulated active ingredients can be attached to the seed surface using a suitable polymeric coating or binder such as film forming polymers such as starches, cellulose polymers, polyvinylacetates and alcohols, naturally derived polymers such as proteins such as soy protein, zein, casein, various water soluble polymers such as polyethyleneoxide and its derivatives to coat individual seeds in a commercial manufacturing system. The binder is selected so that it is responsive to the designated environmental trigger, whether that trigger is moisture, soil pH, sun exposure, seed germination, microbial activity, or simply the passage of time. The binder may also contain one or more hydrophobic components added to impede ingress of water and provide longer release times. Such materials can include, olefinic polymers, waxes, natural and synthetic rubbers such as isoprene, styrene butadiene etc. Once the seed bearing the polymeric coating encounters the environmental trigger, the encapsulated active ingredient particles are released from the seed surface and enter the treatment area (e.g., the soil) around the seed. The release and retention properties of the encapsulation layer then can determine the activity of the active ingredient in the treatment area. Using this system, a coated seed can contain in its coating one or more active ingredients with their own retention and release profiles that can aid seed germination, protect the germinating seed from pests, offer fertilization for the germinating seed and the like.

In one embodiment, a binder such as polyvinyl alcohol (PVOH) is made into a 1% solution in water. To this solution is added different coated AI granules in a ratio that is appropriate for the seed being coated. The mixture is gently agitated to ensure uniform distribution of coated AI granules in the binder. The binder is then applied to the surface of the seed using a tumble blender, high shear blender, film coater, spray coater or any other such coating equipment known in the industry. The coated seeds are then dried and packaged for use. In one embodiment, an anti-caking agent such as silica, or calcium silicate or sodium bicarbonate may be added to the seeds during the coating process so that clumping of coated seeds is minimized.

### EXAMPLES

Materials
SMA® 1000P, Sartomer, Exton, Pa.
SMA® 1000I, Sartomer, Exton, Pa.
SMA® 2000I, Sartomer, Exton, Pa.
SMA® 3000I, Sartomer, Exton, Pa.
Chitosan CG10, Primex, Siglufjordur, Iceland
Chitosan CG110, Primex, Siglufjordur, Iceland
ViCALity ALBAGLOS USP/FCC Precipitated Calcium Carbonate, Specialty Minerals, Bethlehem, Pa.
Silica, fumed, 7 nm, Sigma Aldrich, St. Louis, Mo.
Hydrochloric Acid, ACS reagent, Sigma Aldrich, St. Louis, Mo.
Sodium Hydroxide Pellets, ACS reagent, Electron Microscopy Science, Hatfield, Pa.
Glycerin
Stearic acid
Zein, Freeman Industries
Poly(ethylene-co-vinylacetate)
Crosslinked Poly(acrylic acid) beads, Aldrich
Water-Soluble Active Ingredients (WSAI): Water-soluble active ingredients include herbicides and pesticides comprising, for example, an alachlor (chlorinated acetamide), a benazolin, a bentazone, an imazapyr or triclopyr, or a sulfonyl urea.
Sparingly Soluble Active Ingredients (SSAI): Sparingly soluble active ingredients include herbicides and pesticides comprising Metalachlor, or sulfentrazone (e.g., butsulfentrazone), atrazine
Polyvinylalcohol (Sigma Aldrich, St. Louis, Mo.)
Technical Grade Atrazine (Bosche Scientific, New Brunswick, N.J.)
Anionic Polymer Emulsion ME34935 (Michelman, Cincinnati, Ohio)
Tween 20 (Sigma Aldrich, St. Louis, Mo.)
Sodium Hydroxide (Sigma Aldrich, St. Louis, Mo.)
Hydrochloric Acid (Sigma Aldrich, St. Louis, Mo.)
Corn Seeds (Whole Foods, Austin, Tex.)
Sodium Carboxymethylcellulose (Sigma Aldrich, St. Louis, Mo.)
Amaranth Seeds (Whole Foods, Austin, Tex.)
Organic Seed Starter Potting Soil (Espoma Company, Millville, N.J.)

### Example 1

### Water Solubility of Styrene Maleimide (“SMI”)

Styrene maleimide (“SMI”), at three different ratios of styrene to maleimide (SMA® 1000I, SMA® 2000I, and SMA® 3000I), was added to water with amounts of 1M HCl to solubilize it. A pH of 4-4.5 was used to create an aqueous solution of SMA® 1000I, SMA® 2000I, and SMA® 3000I. These results are consistent with the statements in Sartomer Application Bulletin 4957 “SMA® Imide Resins SMA® 1000I, 2000I, 3000I, and 4000I”, that a pH of 4.5 is required for solubilizing the polymers. Each aqueous solution was then titrated using a base such as NaOH until the polymer precipitated out of the solution, typically at a pH of about 8. Adding acid again to reduce the pH once again solubilized the SMI.

### Example 2

### Preparation of Chitosan Solution

A chitosan solution of CG10 was prepared by dispersing CG10 in deionized water and adding 1M HCl until the chitosan was dissolved. The final pH was approximately 3.5. Chitosan solutions were then further diluted with deionized water to obtain the concentrations set forth in the Examples below.

### Example 3

### Zein Modification of Substrates

A 0.1% solution of Zein was made by diluting 14% Aquazein (Freeman Industries) in basic water (˜10 pH). A 50 g sample of Atrazine in granulated form was selected, and suspended in a 1 liter solution of 0.1% Zein, and pH was lowered to ˜5 using dilute HCl, while stirring to enable Zein deposition on the substrate. The solution was then drained and the substrate dried overnight at 25° C.

### Example 4

### Wax Encapsulation of Water Soluble AI

1 gm of wax (Aldrich, m.p 55 C) and 9 g of a Metribuzin was dry-mixed in a plastic container. The container was then loaded into a high shear mixer such as the FlackTek DAC 150 FVZ-K (FlackTek, Landrum, S.C.). The mixture was shear mixed at ˜2000 rpm for 10 mins. The high shear melts the wax, thereby coating the AI granules. The thickness of the encapsulation material was varied by altering the wax:AI stoichiometry.

### Example 5

### Retention Studies of SMI onto Particles

SMI was adsorbed onto different particle surfaces by controlling the pH. 10 g of silica particles were suspended under agitation in 1% solution of SMA® 1000I solution in pH 4-4.5. The pH was then raised to precipitate the SMA® 1000I onto silica particles according to the methods set forth in Example 1. Retention of the SMA® 1000I was correlated with the measured hydrophobicity of the samples: where hydrophobicity is higher, the retention was better. The experiment was repeated with PCC and cellulose fibers as particle substrates.

### Example 6

### Retention of Herbicides by pi-pi Stacking

Sparingly soluble herbicide such as atrazine which have aromatic rings were retained by mixing them in solutions containing SMI copolymers. 10 g of atrazine was mixed with a 1% solution of SMA® 1000I at pH 5 such that the ratio of atrazine to dry weight of SMA® 1000I in the solution was 99 to 1. As the pH of the solution was raised, solubility of SMA® 1000I was reduced, improving the association of herbicide with the aromatic rings of SMA® 1000I. At around pH 8, SMA® 1000I precipitated onto the herbicide, encapsulating it. This solution was then be used to spray onto soil.

### Example 7

### Retention of Herbicide Molecules in Crosslinked Starch Particles

A 1% solution of Stalok 365 cationic starch in water can be mixed with a predetermined quantity of atrazine in water at 7.5 pH. The mixture is vortexed and treated with a 1% solution of glyoxal. The mixture is then vortexed and dried to obtain a crosslinked mass of starch with atrazine trapped inside. The starch mass is then crushed using a ball mill to obtain uniform sized crosslinked granules containing atrazine which can then be applied to the soil. Suitable hydrophobically modified starches such as FilmKote54 or FilmKote550 can be used in place of cationic starch or mixed with cationic starch to enable retention of hydrophobic herbicides.

### Example 8

### Hydrophobic Encapsulation of AI with Wax with an Oil Diluent

To enhance the biodegradability of the formulation that encapsulates the AI, bioderived oils such as vegetable oils (corn, peanut, etc.) can be added to the encapsulation formulation. 0.7 g of wax (Aldrich, m.p 55 C) and 0.3 g of vegetable oil were dry mixed in a plastic container. To this container, 9 g of a metribuzin was added. The container was then loaded into a high shear mixer such as the FlackTek DAC 150 FVZ-K (FlackTek, Landrum, S.C.). The mixture was shear mixed at ˜2000 rpm for 10 mins. The high shear melted the wax and formed an encapsulation on the metribuzin granules. The thickness of the encapsulation material can be varied by altering the wax:metribuzin stoichiometry. Changing the stoichiometry of oil in the encapsulation composition can alter the release kinetics of the encapsulated material.

### Example 9

### Hydrophobic Encapsulation with Wax and with a Fatty Acid Diluent

To enhance the biodegradability of the formulation that encapsulates metribuzin, bioderived fatty acids such as stearic acid can be added to the formulation. 0.7 g of wax (Aldrich, m.p 55° C.) and 0.3 g of Stearic acid (Aldrich) are dry-mixed in a plastic container. To this container, 9 g of metribuzin was added. The container was then loaded into a high shear mixer such as the FlackTek DAC 150 FVZ-K (FlackTek, Landrum, S.C.). The mixture was shear mixed at ˜2000 rpm for 10 mins. The high shear melts the wax and stearic acid and forms an encapsulation on the AI granules. The thickness of the encapsulation material can be varied by altering the wax:AI stoichiometry. The release kinetics of the encapsulated material can be altered by changing the stoichiometry of fatty acid in the formulation. The anionic group on the stearic acid molecule provides an attachment point for cationic polymers that are useful for soil binding.

### Example 10

### Hydrophobic Encapsulation with a Glycerin Diluent

To enhance the biodegradability of the formulation that encapsulates the AI, glycerin can be added to the formulation. 0.7 g of wax (Aldrich, m.p 55° C.) and 0.3 g of glycerin (Aldrich) are dry-mixed in a plastic container. To this container, 9 g of AI is added. The container is then loaded into a high shear mixer such as the FlackTek DAC 150 FVZ-K (FlackTek, Landrum, S.C.). The mixture is shear mixed at 2000 rpm for 10 mins. The high shear melts the wax and stearic acid and forms a coat on the AI granules. The thickness of the encapsulation material can be varied by altering the wax:AI stoichiometry. The release kinetics of the encapsulation material can be altered by changing the stoichiometry of glycerin in the formulation.

### Example 11

### Hydrophobic Encapsulation with Wax and a Copolymer Additive

To enhance the stability of AI granules in warmer climates, a small amount of higher melting point olefinic polymer or copolymer can be added to the formulation that encapsulates the AI. 0.7 g of wax (Aldrich, m.p 55° C.) and 0.3 g of Poly(ethylene-co-vinylacetate) copolymer are dry mixed in a plastic container. To this container, 9 g of metribuzin is added. The container is then loaded into a high shear mixer such as the FlackTek DAC 150 FVZ-K (FlackTek, Landrum, S.C.). The mixture is shear mixed at ˜2000 rpm for 10 mins. The high shear melts the wax and forms a coat on the AI granules. The thickness of the encapsulation material can be varied by altering the wax:AI stoichiometry. The thermal stability of formulation can be altered by changing the stoichiometry of the higher melting copolymer in the encapsulation material.

### Example 12

### Chitosan Overcoat of the Encapsulated AI

The hydrophobically encapsulated AI from Examples 4, 9, 10, and 11 can be modified with chitosan, as set forth in Example 1. This chitosan overcoat can allow attachment of the hydrophobically encapsulated AI to substrates such as soil.

### Example 13

### Zein Overcoat of the Encapsulated AI

The hydrophobically encapsulated AI from Examples 4, 9, 10, and 11 can be modified with Zein, as set forth in Example 3. This Zein overcoat can allow attachment of the hydrophobically encapsulated AI to substrates such as soil.

### Example 14

### SMI Overcoat of the Encapsulated AI

100 mg of imidized styrene maleic anhydride (SMA® 1000I) was dissolved in 100 mL acidic water (pH4) to make a 0.1% solution. 9 g of hydrophobically modified AI from experiments 9, 10, 11, and 12 was suspended in the SMA® 1000I solution and the pH was raised slowly using dilute NaOH to pH 8 to enable precipitation of SMA® 1000I on the AI granules. This SMA® 1000I overcoat can allow attachment of the hydrophobically modified AI to substrates such as soil.

### Example 15

### Hydrophobic Encapsulation of AI with Soil-Binding Functionality

1 gm of wax (Aldrich, m.p 55° C.) and 0.1 g of 1% SMI in acetone are mixed in a glass container. The solvent is allowed to evaporate while the mixture is mixed, forming a uniform coating of SMI on the wax granules. This modified wax is then mixed with AI in a plastic container. The container is then loaded into a high shear mixer such as the FlackTek DAC 150 FVZ-K (FlackTek, Landrum, S.C.). The mixture is shear mixed at ˜2000 rpm for 10 mins. The high shear melts the wax and forms an encapsulation on the AI granules. The small amount of SMI is then trapped in the encapsulation layer resulting in a cationic functionality that becomes exposed when the coated granules are in an aqueous environment, so that they can attach to anionic substrates such as soil. The thickness of the encapsulation material can be varied by altering the wax:AI stoichiometry.

### Example 16

### Hydrophobic Encapsulation of AI with Cellulosic Derivatives

Solutions of cellulose acetate, cellulose butyrate, cellulose acetate butyrate can be made in acetone at a concentration of 0.1%. The AI to be modified in dry powder form is agitated constantly in a reaction vessel while the cellulose-derivative solution is added slowly. The speed of mixing distributes the cellulosic solution throughout resulting in a uniform coating. The solvent is slowly evaporated leaving behind a stable cellulosic coating on the AI granules.

### Example 17

### Hydrophobic Encapsulation of AI with Cellulosic Derivatives and SMI

To the cellulosic solutions described in Example 16 are added a small amount of SMI to enable introduction of cationic groups that have affinity for anionic substrates such as soil. The AI to be modified in dry powder form can be agitated constantly in a reaction vessel while 0.1% cellulose acetate solution with 0.1% by weight of a SMI solution (e.g., SMA® 1000I) solution is added slowly. The speed of mixing distributes the cellulosic solution throughout resulting in a uniform coating of the AI. The solvent is slowly evaporated, leaving behind a stable cellulosic coating on the AI granules with a small amount of SMI that segregates to the surface owing to the low surface energy of the styrene blocks in the SMI. The cationic groups in the SMI have an affinity for the soil that can allow binding of the AI thereto.

### Example 18

### Plasticized Cellulosic Encapsulants

The cellulosic derivative solutions described in Examples 16 and 17 can be modified with a small amount (0.1% by wt) of plasticizers such as glycerin. The combined solution is then added to the AI granules under agitation as in Examples 16 and 17.

### Example 19

### Use of Absorbent Beads to Encapsulate AI

Crosslinked Poly(acrylic acid) beads can be used to imbibe and trap AI molecules for sustained delivery. A 1% solution of AI is made in DI water. The crosslinked absorbent polymer beads are mixed with the AI solution in the ratio of 1:100. The mixture is agitated until all the AI solution was absorbed into the beads and a dry blend of beads was seen. The beads are then dried at 50° C. to remove water and produce polymer beads encapsulating the AI.

### Example 20

### Providing AI-Imbibed Beads with Soil-Binding Polymeric Coating

A 0.1% solution of chitosan can be added to AI imbibed beads made in Example 19. Chitosan to bead ratio is 1:100. The chitosan readily binds to the anionic polymer surface resulting in a robust ionic bonding between the two. The amine groups on chitosan can bind to the soil and attach the AI-imbibed beads thereto.

### Example 21

### Encapsulation of Coated Active Ingredients onto Seed Surfaces

Samples of encapsulated ingredients prepared in accordance with Examples 3, 4, 6-20 can be prepared as uniform suspensions of sample particles in a binder by mixing a given sample in a 1% solution of polyvinylalcohol and agitating it. A suspension of sample particles can be applied to soybean seeds using a high shear mixer such as the FlackTek DAC 150 FVZ-K (FlackTek, Landrum, S.C.). The soybean seeds can be tumbled in the binder at 3% by weight of the seeds in the mixer at low RPM (500) for 5 minutes in a FlackTek container. The coated seeds can be taken out of the mixer, and an anti-caking agent such as calcium silicate 1% by weight of the coating added to the FlackTek container and then further mixed for additional five minutes. The coated seeds can then be dried to obtain the final product.

### Example 22

### Encapsulation of Atrazine using Spray Drying

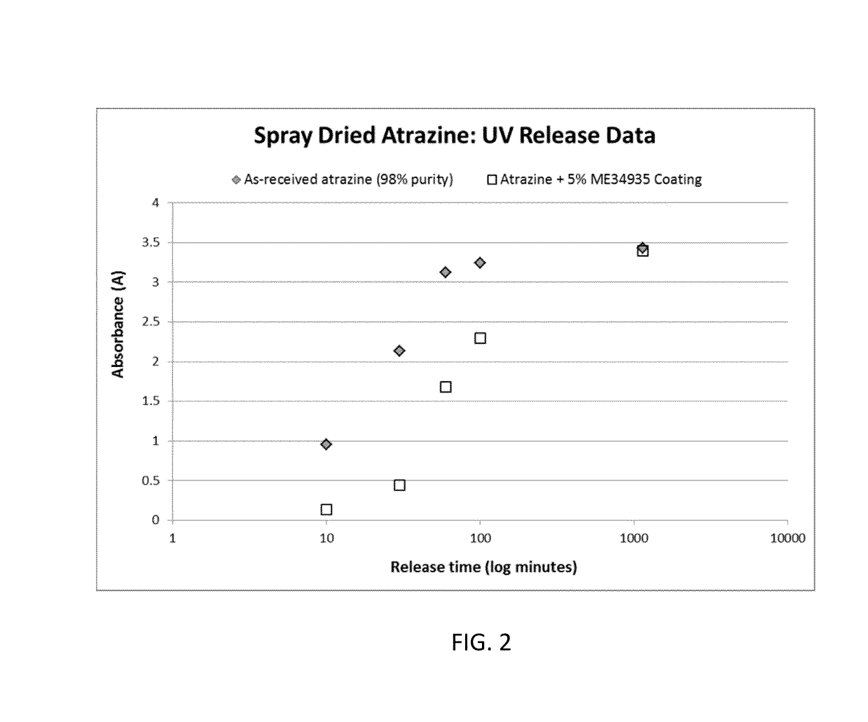

To produce spray-dried atrazine with a polymeric coating, a formulation containing the polymer and atrazine in an aqueous slurry was prepared. First, a 250 mL beaker was filled with 100 mL of DI water and 1 mL of 1% Tween 20. Next, a polymer emulsion or solution was added. For this Example, Michelman ME34935 anionic emulsion was initially used, in a total of 5 mL of a 5% solids dilution so that 0.25 g of total dry weight of polymer was added. Next, 5 g of technical grade atrazine (98% actives) was added to the beaker slowly with high-shear overhead stirring. After all atrazine was added, the slurry was homogenized for 15 seconds and then returned to the overhead stirrer. Next, 0.5 mL of 1 M HCl was added to adjust the pH to 3, thereby precipitating the anionic polymer onto atrazine granules. The solution was then homogenized again for 15 seconds and a magnetic stir bar was added and the beaker was placed on a stir plate. The slurry was fed through a 2-Fluid Nozzle onto a Buchi B-290 Mini Spray Dryer set to 100° C. inlet temperature that atomized the slurry and dried the coated atrazine. The atrazine was collected in the product collection jar and analyzed with a UV-Vis spectrometer to determine release kinetics, with results as shown in FIG. 2. A similar procedure was repeated with a cationic polymer, SMA 2000I instead of the anionic emulsion described above, but the pH adjustment was in the opposite direction (0.5 mL 1 M NaOH was added to achieve pH of 9 or higher).

### Example 23

### Coating of Encapsulated Active Ingredients onto Seed Surfaces

Corn seeds were chosen as a vehicle for seed coating because of their wide usage in industry and because of their high susceptibility to pests in the field. Atrazine was chosen as the active ingredient for pest control because it is used in the field to prevent weeds that interfere with corn growth. In the growing experiments, corn seeds were coated with a binder containing atrazine in technical form (98% purity Atrazine from Bosche Scientific) (the “As-received System” controls), or in spray-dried form (88-93% overall activity, spray dried with 5-10% by weight an anionic polymer or cationic polymer coating) (the “Experimental System”). Sodium carboxymethylcellulose (Sodium-CMC) was used as a binder to coat atrazine (As-received (technical form) or Experimental (spray dried form)) onto the corn seeds; by weight of the corn seeds, Sodium-CMC was dosed at 0.15% in a 1.5% solids solution to the corn seeds. Actual atrazine dosage to the planters was 0.04% solids dosage to the corn seeds. The corn seeds were air dried at room temperature for 20 minutes.

### Example 24

### Planting of Encapsulated Seeds

Corn seeds were prepared for planting as described in Experiment 23. For the blanks, A1 and B1, untreated corn seeds without Sodium-CMC binder and without atrazine were used. For the As-Received System controls, A2 and B2, corn seeds coated with Sodium-CMC binder and technical purity atrazine were used. Experimental Systems were prepared as follows: the experimental conditions A3 and B3 utilized corn seeds coated as described in Experiment 23 with atrazine spray dried with anionic polymer coating as described in Experiment 22; the experimental conditions A4 and B4 also utilized corn seeds coated as described in Experiment 23, with atrazine spray dried with cationic polymer coating as described in Experiment 22.

As shown in Table 1, corn seeds were planted in seed starter trays (A1-A4) or in pots (B1-B4) on day 0. In the seed starter trays, corn seeds were planted 3 per cell in 6 cells, for a total of 18 seeds per condition. In the pots, corn seeds were planted 10 per pot to represent the overall atrazine dosage of 2 lbs/acre. In the pots, 40 amaranth seeds (representing weed growth) were also planted in pots B1-B4 on day 0. On Day 8, seedlings from the seed planters (A1-A4) were transferred to pots, 10 seedlings per condition. Also on Day 8, 40 amaranth seeds were planted in each of the pots A1-A4. During seedling growth (Day 0-Day 8 for all plants A1-A4 and B1-B4), the planters were watered with 60 mL of sprays each and then covered with clear plastic bags to retain moisture; they were left under indirect “sunlight” (indoor metal-halide lamps on 12-hour light timers) until corn seedlings were 1-2″ in height. At that point, plastic bags were removed. During subsequent growth stages, the plants were in direct sunlight for 12 hours per day and watered 120 mL/day with an automatic drip system (Claber Oasis Automatic Watering System). During corn growth, amaranth activity was measured by counting the number of amaranth plants in each condition. When corn plants reached 18″ in height, they were terminated, and final growth analysis was tabulated.

| | Spray Dried | Seed Coating | Atrazine Dosage | Atrazine Dosage | # Corn | Day | # Amaranth | Day |
|---|---|---|---|---|---|---|---|---|
| ID | Coating | Binder | (wt. atrazine/wt. corn) | (lbs/acre) | Seeds | Planted | Seeds | Planted |
| A1 | N/A | None | 0.000% | 0.0 | 10 | 0 | 40 | 8 |
| A2 | None | Sodium-CMC | 0.042% | 2.0 | 10 | 0 | 40 | 8 |
| A3 | Anionic Polymer | Sodium-CMC | 0.042% | 2.0 | 10 | 0 | 40 | 8 |
| A4 | Cationic Polymer | Sodium-CMC | 0.042% | 2.0 | 10 | 0 | 40 | 8 |
| B1 | N/A | None | 0.000% | 0.0 | 10 | 0 | 40 | 0 |
| B2 | None | Sodium-CMC | 0.042% | 2.0 | 10 | 0 | 40 | 0 |
| B3 | Anionic Polymer | Sodium-CMC | 0.042% | 2.0 | 10 | 0 | 40 | 0 |
| B4 | Cationic Polymer | Sodium-CMC | 0.042% | 2.0 | 10 | 0 | 40 | 0 |

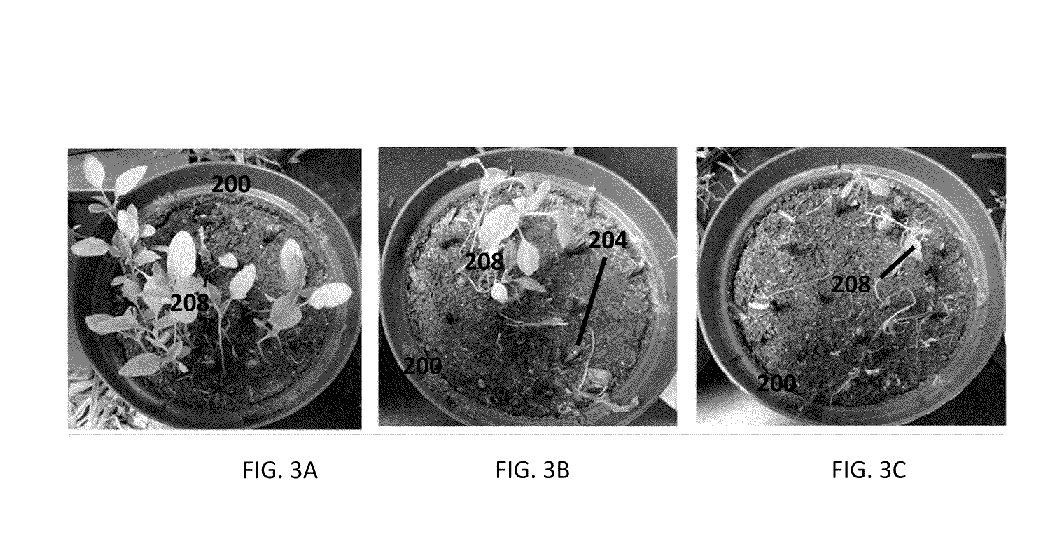

Results from some of these experiments are depicted in the photographs on FIG. 3. In the soil-containing pots 200 in FIG. 3, the corn seedlings were pruned at the conclusion of the study so that only their stems 204 remained. The photographs in FIG. 3 show the number of amaranth plants 208 under each of three conditions: the control, where no atrazine was used (FIG. 3A), the unencapsulated atrazine-coated corn seeds (As-received System) (FIG. 3B), and the anionic emulsion encapsulated atrazine-coated seeds (Experimental System) (FIG. 3C). The photographs show that the greatest number of amaranth plants 208 is present in FIG. 3A, with fewer 208 in FIG. 3B, and fewest 208 in FIG. 3C. The results of the above experiments indicated a substantial reduction in planted weeds 208 with the Experimental System encapsulated atrazine-coated seeds compared to untreated seeds (no atrazine) and As-received System atrazine-coated seeds. The Experimental System encapsulated atrazine performed 70% better than control and 20% better than the As-Received System in controlling the weeds 208.

While not tested in this Example, another advantage of the Experimental System is that the active ingredient is dosed at its target (here, the corn seeds) and has dramatically reduced mobility, thus reducing its runoff and avoiding the need for an active ingredient to be sprayed over a large area as a dilute solution. In actual use, an agent like the atrazine used in this Example that is applied conventionally can be washed off the soil surface during rain, and can collect in water reservoirs (rivers, ponds, lakes, oceans, etc.) and then dissolve. With the active ingredient applied directly to a coated seed and kept in proximity to the seed itself by encapsulation, as disclosed herein, its mobility is limited by its solubility in close proximity around the seed, preventing long-distance mobility.

### Equivalents

While this invention has been particularly shown and described with references to preferred embodiments thereof, it will be understood by those skilled in the art that various changes in form and details may be made therein without departing from the scope of the invention encompassed by the appended claims.

1. A seed coating system comprising:
an encapsulated active ingredient particle comprising an active ingredient and an encapsulation layer with a preselected release profile,
and a polymeric seed coating, wherein the polymeric seed coating releasably affixes the encapsulated active ingredient particle in proximity to a surface of a seed.

2. The system of claim 1, wherein the encapsulation layer is polymeric.

3. The system of claim 1, wherein the encapsulation layer is rigid or semi-rigid.

4. The system of claim 1, wherein the encapsulated active ingredient particle formed as a hollow sphere.

5. The system of claim 4, further comprising an external polymeric layer over the hollow sphere.

6. The system of claim 1, wherein the encapsulated active ingredient particle comprises two or more active ingredients within a single encapsulated active ingredient particle.

7. The system of claim 1, wherein the encapsulation layer is selected from the group consisting of SMA and SMI, hydrophobic proteins, other proteins, starches, hydrophobically derivatized starches, hydrophobically modified water soluble proteins and naturally derived polymers suitably modified by entities that enable them to bind to the delivery area, natural waxes, alkylchain fatty acids and their derivatives.

8. The system of claim 1, wherein the polymeric seed coating is biodegradable.

9. The system of claim 1, further comprising a second active ingredient particle having either a second active ingredient or a second preselected release profile.

10. A seed coating system comprising a plurality of active ingredient layers,
wherein a first active ingredient layer comprises
a first encapsulated active ingredient, wherein the first encapsulated active ingredient is encapsulated in a first polymer, and wherein the polymer comprises a first binding site that binds the active ingredient and a second binding site for binding to a delivery area, and
a binder to releasably affix the encapsulated active ingredient to at least one of a seed surface or a second active ingredient layer, and
wherein a second active ingredient layer comprises
a second encapsulated active ingredient, wherein the second encapsulated active ingredient is encapsulated in a second polymer which may be the same as or different from the first polymer, and
a binder to releasably affix the encapsulated active ingredient to at least one of the first active ingredient layer and a subsequent active ingredient layer.

11. A retention system for an active ingredient on a seed, comprising:
a coated particle bearing the active ingredient,
a polymeric overcoat covering the coated particle and permitting controlled release of the active ingredient therethrough, and
a binder that coats the seed and that attached the coated particle thereto.

12. A method of producing more effective germination of a seed, comprising:
preparing the seed coating system of claim 1,
applying an effective amount of the seed coating system to a seed to form a coated seed,
introducing the coated seed into a treatment area,
and exposing the coated seed in the treatment area to a germination condition,
wherein the coated seed responds to the germination condition to germinate more effectively than an identical seed without the seed coating system applied.

13. The method of claim 12, wherein the germination condition is selected from the group consisting of soil moisture, soil pH, temperature, sun exposure, nutrient exposure, and passage of time.

14. A seed coated with the seed coating system of claim 1.

15. A seed coated with the seed coating system of claim 10.
